(19) United States
(12) Patent Application Publication
(10) Pub. No.: US 2004/0161656 A1
(43) Pub. Date: Aug. 19, 2004

(54) Fuel cell

(75) Inventor: Atsushi Sadamoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/717,567

(22) Filed: Nov. 21, 2003

(30) Foreign Application Priority Data
Nov. 22, 2002 (JP) 2002-339831

(51) Int. Cl. H01M 8/02; H01M 8/10

(52) U.S. Cl. 429/38; 429/30

(57) ABSTRACT

A separator for a fuel cell is provided with an inlet port for receiving fluid used in the fuel cell, an outlet port for exhausting exhaust from the fuel cell, a main flow path connected to the inlet port and two or more branch flow paths. Each of the branch flow paths has a first end and second end. The first end is provided with a throttle communicating with the main flow path. The second end communicates with the outlet port.

### CROSS-REFERENCE TO RELATED APPLICATIONS

This application is based upon and claims the benefit of priority from the prior Japanese Patent Application No. 2002-339831 (filed Nov. 22, 2002); the entire contents of which are incorporated herein by reference.

### BACKGROUND OF THE INVENTION

1. Field of the Invention

The present invention relates to a fuel cell and, more particularly, relates to a separator for the fuel cell, which effectively prevents clogging of a fluid in any of the flow paths therein.

2. Description of the Related Art

In a proposed art, a fuel cell is provided with a membrane electrode assembly which is provided with a cathode electrode, an anode electrode and a polymer electrolyte membrane put therebetween. The fuel cell is further provided with a pair of separators which are provided with gas flow paths for supplying air or fuel to the membrane electrode assembly. The separators are attached on both sides of the membrane electrode to form a set of the fuel cell. In general, two or more sets of the fuel cells are stacked to form a stack structure to increase generating electric power.

A related art is disclosed in Japanese Patent Application Laid-open No. H10-199552.

### SUMMARY OF THE INVENTION

According to the related art, a manifold is applied for substantially even supply of the air and the fuel to the respective fuel cells. However, it is commonly found that water generated by the fuel cell reaction clogs any one of the flow paths in the separators. The clogging causes interruption of gas flow and uneven supply to the respective flow paths. This leads to instability of power generation of the fuel cell.

The present invention is achieved in view of the above problem and an object thereof is provision of a separator for a fuel cell, which effectively prevents clogging of a fluid in any of the flow paths therein.

According to a first aspect of the invention, a separator for a fuel cell is provided with an inlet port for receiving fluid used in the fuel cell, an outlet port for exhausting exhaust from the fuel cell, a main flow path connected to the inlet port and two or more branch flow paths. Each of the branch flow paths has a first end and second end. The first end is provided with a throttle communicating with the main flow path. The second end communicates with the outlet port.

According to a second aspect of the invention, a separator set for two or more fuel cells is provided with a manifold supplying fluid used in the fuel cells and two or more flow paths respectively connected to the manifold, each of the flow paths including a throttle and two or more separators each including an inlet port and an outlet port, the inlet ports respectively being connected to the flow paths.

According to a third aspect of the invention, a fuel cell is provided with the separator or the separator set and an electrolyte membrane having a pair of electrodes sandwiched therebetween.

According to a fourth aspect of the invention, a fuel cell system is provided with the fuel cell, a fuel supply unit and an oxidizer supply unit.

### BRIEF DESCRIPTION OF THE DRAWINGS

FIG. 1A is a plan view of a separator according to a first embodiment of the present invention;

FIG. 1B is a cross sectional view of the separator taken from the line 1B-1B shown in FIG. 1A;

FIG. 1C is a cross sectional view of the separator taken from the line 1C-1C shown in FIG. 1A;

FIG. 2A is an explanation drawing about a pressure drop in a steady state;

FIG. 2B is an explanation drawing about a pressure drop in a case where a water droplet clogs a flow path;

FIG. 3A is graph showing flow rates of respective flow paths in a steady state;

FIG. 3B is graph showing flow rates of respective flow paths in a case where one of the flow paths is clogged;

FIG. 3C is graph showing flow rates of respective flow paths in a case where one of the flow paths is clogged according to the first embodiment of the present invention;

FIG. 4A shows a model flow path;

FIG. 4B is a graph showing voltage drop in a case where a coefficient K is less than 0.5;

FIG. 4C is a graph showing voltage drop in a case where a coefficient K is equal to 0.5;

FIG. 4D is a graph showing voltage drop in a case where a coefficient K is larger than 0.5;

FIG. 5 is a plan view of a separator according to a second embodiment of the present invention;

FIG. 6 is a schematic perspective view of separators according to a third embodiment of the present invention;

FIG. 7 is an exploded perspective view of a fuel cell according to an embodiment of the present invention; and

FIG. 8 is a perspective view of a fuel cell stack according to an embodiment of the present invention.

### DETAILED DESCRIPTION OF THE INVENTION

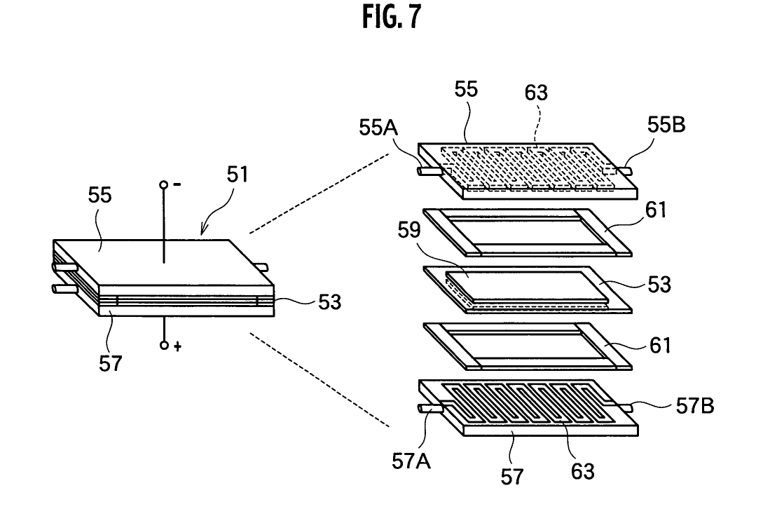

A direct methanol fuel cell (“DMFC” hereinafter) 51 of a general constitution is provided with a pair of separators 55 and 57 and an electrolyte membrane 53 put therebetween as shown in FIG. 7. On both faces of the electrolyte membrane 53, a pair of electrodes 59 each composed of a catalyst layer and carbon paper are respectively accumulated. Further, a pair of packings 61 surrounding the electrodes 59 are disposed on both faces of the electrolyte membrane 53. Each of the separators 55 and 57 is provided with a flow path 63 faced to the electrolyte membrane 53.

The aforementioned constitutional elements are fixed with a fastening mechanism (not shown) to form the fuel cell 1.

Methanol aqueous solution is supplied to the flow path 63 of the separator 55 via a fuel inlet port 55A as fuel and ambient air is supplied to the flow path 63 of the separator 57 via an air inlet port 57A as oxidant, thereby the fuel cell 1 generates electric power from the fuel and the air. In the course of the power generation, unreacted methanol, water, carbon dioxide gas and such are exhausted from a fuel outlet port 55B and unreacted air, water and such are exhausted from an air outlet port 57B.

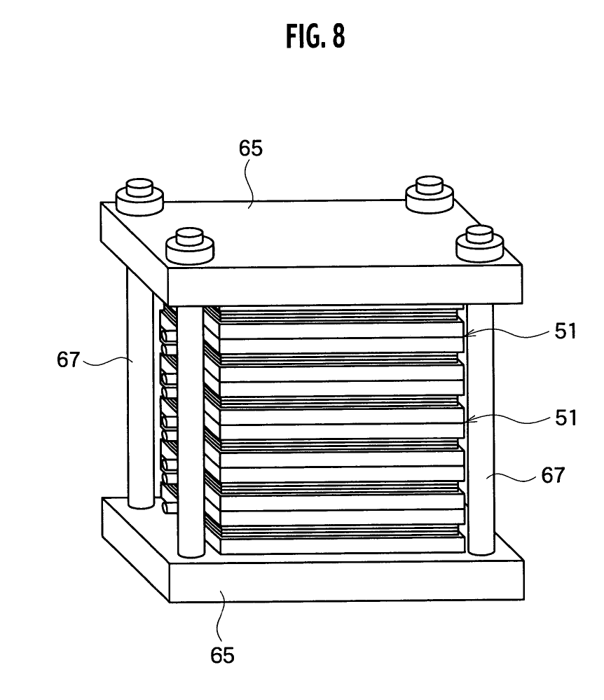

In general, practically, a plurality of the fuel cells 51 are stacked to form a stack structure as shown in FIG. 8. The stack structure is fixed with a pair of plates 65 and a plurality of fastening members 67.

The present invention is applied to the flow path and the inlet ports of the separators of the fuel cell 51.

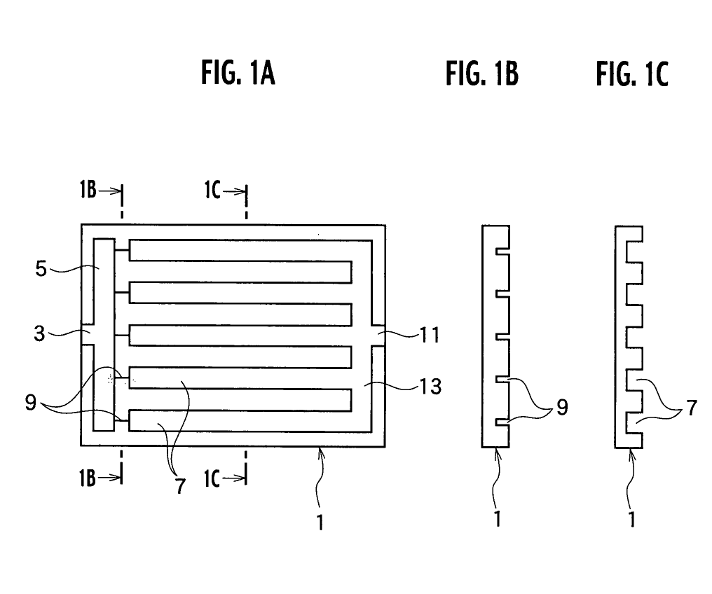

A first embodiment of the present invention will be described hereinafter with reference to FIGS. 1A, 1B and 1C.

A separator 1 according to the first embodiment is provided with a main flow path 5 communicating with an inlet port 3 and a plurality of branch flow paths 7 arranged in parallel with each other. Throttles 9 are respectively formed between the main flow path 5 and upstream ends of the branch flow paths 7, thereby each of the branch flow paths 7 communicates with the main flow path 5 via the throttle 9. Downstream ends of the branch flow paths 7 are connected to an exhaust manifold 13 which communicates with an outlet port 11. The main flow path 5 is formed to be a relatively wide groove and is connected to the respective branch flow paths 7 so as to function as a manifold.

More particularly, the inlet port 3, the main flow path 5, the branched flow paths 7, the exhaust manifold 13 and the outlet port 11 are formed to be grooves substantially having even widths and depths. The throttles 9 are formed in a slit-like shape.

Furthermore, the throttles 9 are configured so that pressure loss at the throttles 9 is enough large in comparison with pressure loss at the flow paths downstream thereof when a gas flows therethrough. Namely, the pressure loss at the throttle 9 is represented by (P1−P2) and the pressure loss from the branch flow path 7 to the outlet port 11 is represented by (P2−P3), where a pressure at the inlet port 3 is P1, a pressure at upstream ends of the branch flow paths 7 is P2 and a pressure at the outlet port 11 is P3. The throttles 9 and the branch flow path 7 are configured so that the pressure losses thereof constantly satisfy an inequality of (P1−P2)>K(P2−P3), where K is a coefficient. The coefficient K is preferably set to be a larger value and more preferably set to be 0.5 or more. In other words, the throttle 9 and the branch flow path 7 are configured so that the pressure loss at the throttle 9 is larger than 0.5 times of the pressure loss at the branch flow path 7.

Pressure loss can be estimated as follows. Assuming a model flow path in which gas flows through a cylindrical tube in a laminar flow state, Hagen-Poiseuille's law dictates that a pressure loss in the model flow path is represented by an equation ΔP=128 μLQ/pd⁴, where ΔP represents the pressure loss, μ represents a viscosity of the gas, L and d respectively represent a length and an inner diameter of the model flow, Q represents a flow rate of the gas and p represents the circle ratio. The throttle 9 and the branch flow path 7 can be approximated by two model flow paths connected in series, which have different inner diameters and lengths. Because p and Q are in common, the pressure losses are proportional to L/d⁴ of the respective model flow paths. For example, to set the pressure loss of the throttle 9 to be ten times larger than the pressure loss of the branch flow path 7, it is necessary that the throttle 9 are configured to be 5 mm in length and 0.7 mmF in inner diameter and the branch flow path 7 are configured to be 32 mm in length and 2 mmF in inner diameter. In other words, the throttle 9 and the branch flow path 7 can be configured so that the aforementioned inequality is satisfied, when the lengths and the inner diameters thereof are appropriately set. In this consideration, a cylindrical tube was assumed as the model flow path, however, various model flow paths such as a rectangular tube or a tapered tube can be assumed in view of substantive shapes of the respective flow paths. In a case of the rectangular tube, a similar consideration can be done by means of substitute a correspondent diameter 2ab/(a+b) for the diameter d, where a and b respectively represent height and width of cross-section of the rectangular tube. In a case where an assumed model flow path is not a simple shape, the aforementioned equation dictated by Hagen-Poiseuille's law might not be employed. Then an equivalent equation can be drawn from Navier-Stokes's formula and employed to find how to configure the throttle 9 and the branch flow path 7.

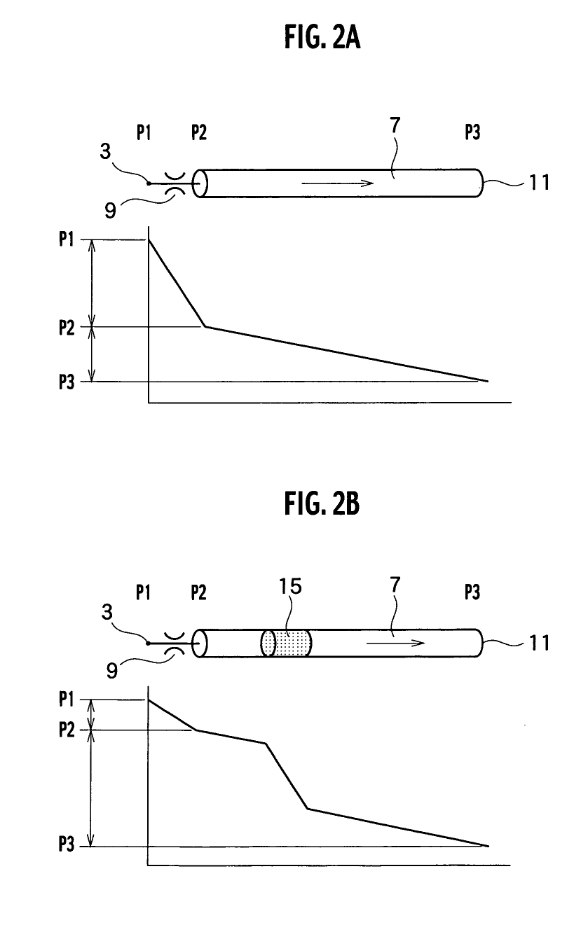

A pressure change of the gas from upstream of the throttle 9 to the outlet port 11 can be schematically shown in FIGS. 2A, 2B.

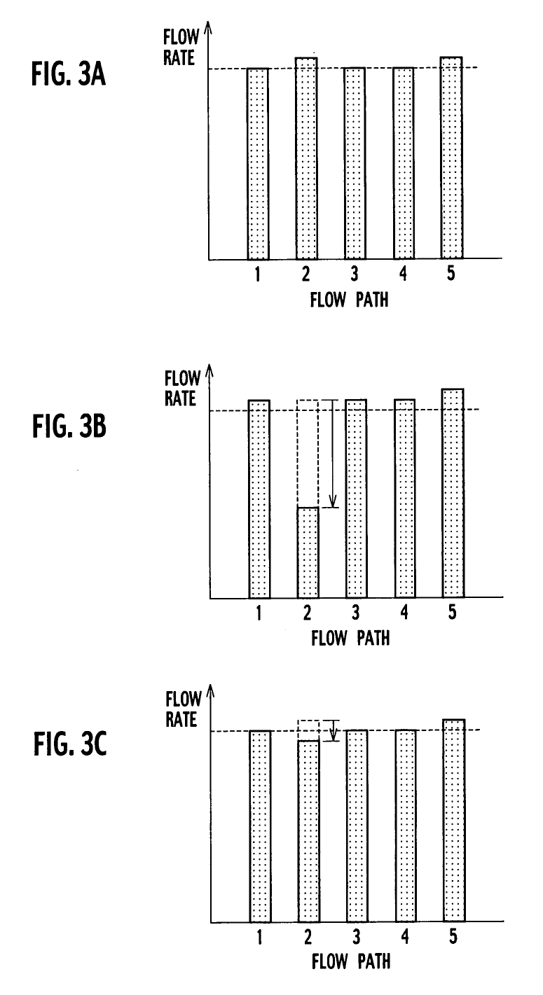

When the gas, in this case the fuel or the air, flows into the inlet port 3, the gas is evenly distributed and flows into the respective branch flow paths 7. In a case where any of the flow paths are not clogged by water generated by the fuel cell reaction, the pressure loss (P1−P2) at the throttles 9 is kept larger than 0.5 times of the pressure loss (P2−P3) from the branch flow paths 7 to the outlet port 11. Flow rates of the respective branch flow paths 7 have small variations as shown in FIG. 3A, therefore, the flow rates are considered to be substantially even.

Assuming that a water droplet 15 generated by the fuel reaction clogs one of the branch flow paths 7 as shown in FIG. 2B, the flow rate thereof is decreased and a pressure between the water droplet 15 and the throttle 9 is increased. The increased pressure presses the water droplet 15 toward the outlet port 11. Thereby the water droplet 15 is exhausted from the outlet port 11 and the clogging is actively dissolved.

If the throttles 9 were omitted and the main flow path 5 and the branch flow paths 7 were directly connected in the aforementioned constitution, pressure and flow rate changes could be considered as the following. Assuming that clogging by the water droplet 15 happens somewhere in the branch flow paths 7, flow resistance thereof increases and thereby flow resistance of whole of the flow path system is increased so that the pressure thereof is increased. The increased pressure makes slightly larger flow rates in the branch flow paths 7 other than the clogged branch flow path 7. Instead, because the whole flow rate does not increase, the flow rate of the clogged branch flow path 7 considerably decreases as shown in FIG. 3B. The gas flow with such decreased flow rate may not move the water droplet 15. Therefore actively dissolution of the clogging is cannot be expected.

As understood from the aforementioned descriptions, the constitution according to the first embodiment of the present invention makes it possible to actively dissolve clogging of the flow paths as well as to suppress the flow rate variation among the branch flow paths 7 as shown in FIG. 3C.

Furthermore, the throttle 9 makes an increased pressure in the clogged branch flow path 7 so as to push out the water droplet 15 and further prevents the increased pressure from escaping from the clogged branch flow path 7. Performance decrement of the power generation caused by clogging of the flow paths is prevented and stable power generation can be expected.

Advances of the aforementioned constitution have been tested by experiments described below.

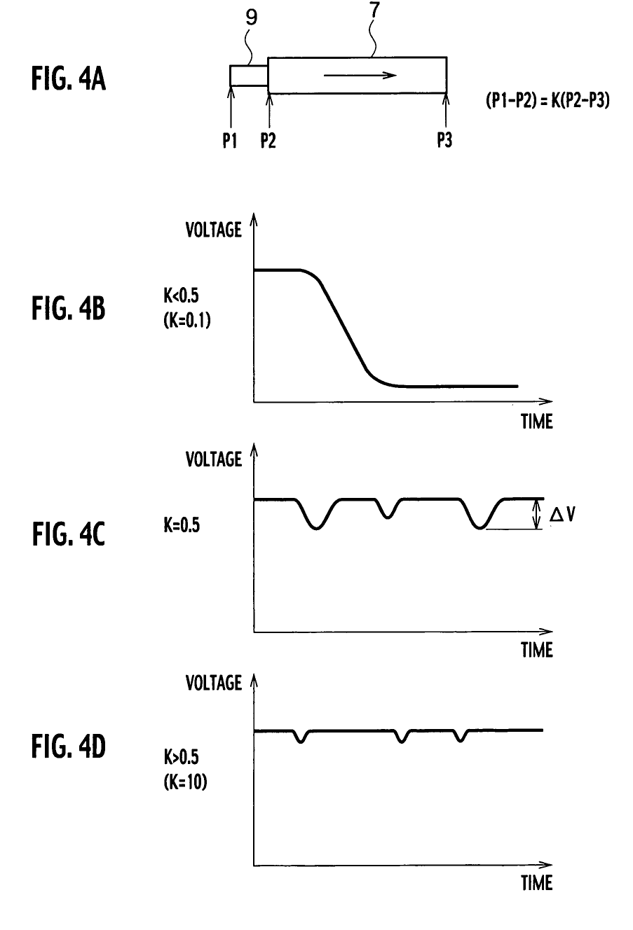

A model flow path composed of a throttle and a branch flow path, all of which merely consist of solid walls, as shown in FIG. 4A, are employed in the experiments. Liquid or gas fluid flows in the model flow path in a laminar flow condition. It is assumed that the flow rates at an inlet end and an outlet end are perfectly equal. (In other words, there is no flow through the wall surface.)

Three variations of throttle diameters were tested. Results are shown in FIGS. 4B, 4C and 4D, in which relations between a voltage of the fuel cell and a coefficient K, where K=(P1−P2)/(P2−P3), are drawn.

When K<0.5 (for example, K=0.1), the voltage drops due to clogging of the flow paths and the voltage drop lasts for a long time as shown in FIG. 4B. Such a result is not preferable from a practical standpoint.

When K=0.5, voltage drops caused by clogging are often observed, however, the voltage drops are immediately dissolved as shown in FIG. 4C. The voltage drops (ΔV) fall in a trouble-free range from a practical standpoint.

When K>0.5 (for example, K=10), voltage drops caused by clogging are often observed. However, the voltage drops are quite minimal and are immediately dissolved as shown in FIG. 4D. The voltage drops (ΔV) fall in a trouble-free range and are considered to be preferable.

As will be understood from the aforementioned descriptions, the voltage drop of the fuel cell is related to the coefficient K, in other words, the throttle diameter. A threshold of K is 0.5 and preferable stability of the voltage can be obtained when K>0.5. Namely, when a relation (P1−P2)>0.5(P2−P3) is satisfied, stability of the fuel cell is obtained.

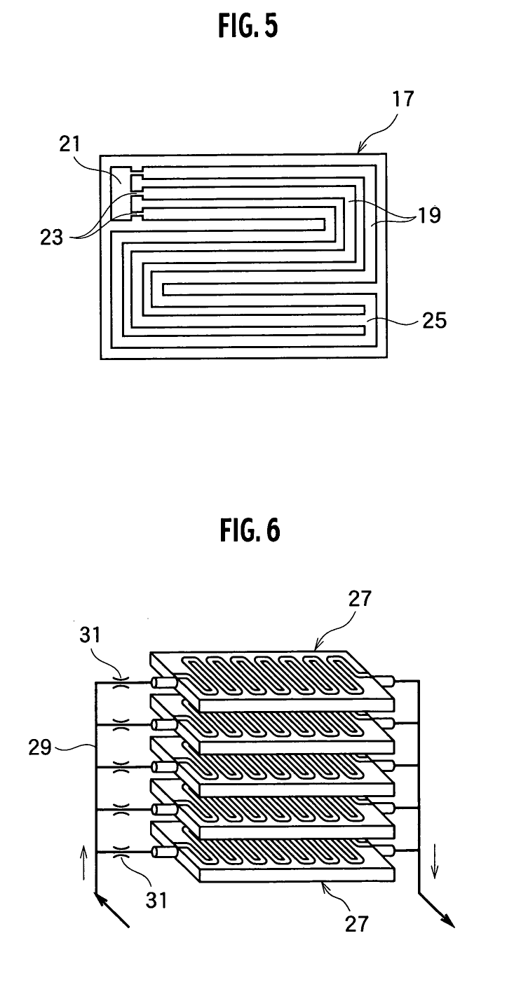

A second embodiment of the present invention will be described hereinafter with reference to FIG. 5. A main flow path 21 is formed in a vicinity of a corner of a separator 17. Throttles 23 are formed in a similar manner with the aforementioned first embodiment and are respectively connected to branch flow paths 19. The branch flow paths 19 are formed in “S” letter shapes and connected to an outlet manifold 25. The constitution brings about the same effect as the constitution of the first embodiment.

A third embodiment of the present invention will be described hereinafter with reference to FIG. 6. In the third embodiment, a plurality of separators 27 are accumulated with each other. The separators 27 are not provided with a throttle, unlike the above first and second embodiments. A manifold 29 is connected to respective inlet ports of the separators 27 and branched flow paths of the manifold 29 are respectively provided with throttles 31. In such constitution, the same effect as the constitutions of the first and second embodiments are brought about.

In the above descriptions, an example in which a liquid droplet enters in a gas flow is exemplified, however, the present invention can be applied to a case where a gas bubble clogs a liquid flow. In this case, the same effect as the aforementioned description can be brought about. Thereby the clogging by the gas bubble can be effectively dissolved.

Furthermore, the throttles are disposed between the manifold and the branch flow paths in the above descriptions, however, the throttles can be disposed anywhere upstream of positions where water droplets or gas bubbles may be generated.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A separator for a fuel cell, comprising:
an inlet port receiving fluid used in the fuel cell;
an outlet port exhausting exhaust from the fuel cell;
a main flow path connected to the inlet port; and
two or more branch flow paths, each of the branch flow paths having a first end and second end, the first end comprising a throttle communicating with the main flow path, the second end communicating with the outlet port.

2. The separator of claim 1, wherein:
each of the throttles and the branch flow paths is configured so that pressure loss at the throttle is larger than 0.5 times of pressure loss at the branch flow path.

3. A separator set for one or more fuel cells, comprising:
a manifold supplying fluid used in the fuel cells;
two or more flow paths respectively connected to the manifold, each of the flow paths including a throttle; and
two or more separators each including an inlet port and an outlet port, the inlet ports respectively being connected to the flow paths.

4. The separator set of claim 3, wherein:
each of the throttles and the flow paths is configured so that pressure loss at the throttle is larger than 0.5 times of pressure loss at the flow path.

5. A fuel cell comprising:
an electrolyte membrane having a pair of electrodes sandwiching the electrolyte membrane; and
a pair of separators sandwiching the pair of electrodes, each of the separators comprising;
an inlet port receiving fluid used in the fuel cell,
an outlet port exhausting exhaust from the fuel cell,
a main flow path connected to the inlet port, and
two or more branch flow paths, each of the branch flow paths having a first end and second end, the first end comprising a throttle communicating with the main flow path, the second end communicating with the outlet port.

6. The fuel cell of claim 5, wherein:
each of the throttles and the branch flow paths is configured so that pressure loss at the throttle is larger than 0.5 times of pressure loss at the branch flow path.

7. A fuel cell system comprising:
a fuel cell comprising;
an electrolyte membrane having a pair of electrodes sandwiching the electrolyte membrane; and
first and second separators sandwiching the electrodes, each of the separators comprising;
an inlet port receiving fluid used in the fuel cell,
an outlet port exhausting exhaust from the fuel cell,
a main flow path connected to the inlet port, and
two or more branch flow paths, each of the branch flow paths having a first end and second end, the first end comprising a throttle communicating with the main flow path, the second end communicating with the outlet port;
a fuel supply unit supplying fuel to the first separator; and
an oxidizer supply unit supplying gas including oxidizer to the second separator.

8. The fuel cell system of claim 7, wherein:
each of the throttles and the branch flow paths is configured so that pressure loss at the throttle is larger than 0.5 times of pressure loss at the branch flow path.

9. The fuel cell system of claim 7, wherein the fuel cell comprises a plurality of the fuel cells accumulated with each other.

10. A fuel cell comprising:
first and second separator sets, each of the separator sets comprising;
a manifold supplying fluid used in the fuel cell;
two or more flow paths respectively connected to the manifold, each of the flow paths including a throttle;
two or more separators each including an inlet port and an outlet port, the inlet ports respectively being connected to the flow paths; and
one or more electrolyte membranes each having a pair of electrodes sandwiching the electrolyte membrane, each of the electrolyte membrane being sandwiched by the first separator and the second separator.

11. The fuel cell of claim 10, wherein:
each of the throttles and the flow paths is configured so that pressure loss at the throttle is larger than 0.5 times of pressure loss at the flow path.

12. A fuel cell system comprising:
a fuel cell comprising;
first and second separator sets, each of the separator sets comprising;
a manifold supplying fluid used in the fuel cell;
two or more flow paths respectively connected to the manifold, each of the flow paths including a throttle;
two or more separators each including an inlet port and an outlet port, the inlet ports respectively being connected to the flow paths; and
one or more electrolyte membranes each having a pair of electrodes sandwiching the electrolyte membrane, each of the electrolyte membrane being sandwiched by the first separator and the second separator;
a fuel supply unit supplying fuel to the first separator; and
an oxidizer supply unit supplying gas including oxidizer to the second separator.

13. The fuel cell system of claim 12, wherein:
each of the throttles and the flow paths is configured so that pressure loss at the throttle is larger than 0.5 times of pressure loss at the flow path.
